(19) United States
(12) Patent Application Publication
(10) Pub. No.: US 2012/0158461 A1
(43) Pub. Date: Jun. 21, 2012

(54) CONTENT MANAGEMENT AND ADVERTISEMENT MANAGEMENT

(75) Inventors: Raul I. Aldrey, Plano, TX (US); Donald H. Relyea, Dallas, TX (US); Michael John D'Argenio, Hoboken, NJ (US); George M. Higa, Dallas, TX (US)

(73) Assignee: VERIZON PATENT AND LICENSING INC., Basking Ridge, NJ (US)

(21) Appl. No.: 12/971,024

(22) Filed: Dec. 17, 2010

(51) Int. Cl. G06Q 30/00; G06Q 10/00

(52) U.S. Cl. 705/7.35; 705/14.55; 705/7.29; 705/14.41

(57) ABSTRACT

A method including providing content for purchasing and viewing by users, wherein the purchasing includes buying or renting content; performing real-time tracking pertaining to the purchasing and the viewing of content by the users based on the providing; generating real-time tracking information based on the performing, wherein the real-time tracking information identifies a content purchased by the user and a user device used by the user to view the content; automatically creating a content promotion or a campaign ad based on the real-time tracking information; and automatically providing the content promotion or the campaign ad to the users.

### BACKGROUND

Consumer demand for media is increasing. For example, consumers often watch and/or listen to various media at home, while traveling, at work, etc. As a result, the number of communication channels for delivering media content and the number of different types of devices for playing the content has also increased.

### BRIEF DESCRIPTION OF THE DRAWINGS

FIG. 1 is a diagram illustrating an exemplary network that includes a digital distribution clearinghouse (DDC) for processing content;

FIG. 2 is a diagram illustrating an exemplary embodiment of the DDC illustrated in FIG. 1;

FIG. 3 is a diagram illustrating an exemplary environment that includes an exemplary embodiment of a content manager;

FIG. 4 is a diagram illustrating an exemplary environment that includes an exemplary embodiment of an advertiser manager;

FIG. 5 is a diagram illustrating exemplary components of an exemplary embodiment of one or more devices illustrated in FIGS. 1-4;

FIG. 6 is a flow diagram illustrating an exemplary process for automatically creating a content promotion to users based on real-time tracking information; and

FIG. 7 is a flow diagram illustrating an exemplary process for automatically creating a campaign ad.

### DETAILED DESCRIPTION

The following detailed description refers to the accompanying drawings. The same reference numbers in different drawings may identify the same or similar elements.

A digital data clearinghouse (DDC) may permit a user (e.g., a DDC operator, a DDC administrator, etc.) to define or create work units, use these work units to compose a work flow and, to dynamically provide for customer-requested processes for content distribution. When the user submits a service order for processing content on behalf of a customer, the DDC may obtain, from the work flow associated with a work order, work unit tasks that correspond to the work units. The DDC may perform all or some of these tasks.

The term “content,” as used herein, may include for example, multimedia content (e.g., text-based content, audio and video such as a movie, a show, a television program, broadcast of a live event (e.g., sporting event, concert, etc.)), e-books, or another type of content or asset. Content may include, for example, time-shifted content, summaries of content, and a segment of a full portion of content. Additionally, content may include user-generated content (e.g., videos, print, etc.).

The term “work unit,” as used herein, may refer to a description of a set of one or more operations that the DDC may perform pertaining to the ingestion, transformation, and distribution of content. For example, the transforming of content may include overlaying subtitles on a video, inserting advertisements into a video, transcoding content from one format to another format, etc. A further description of a work unit is provided below.

The term “work flow,” as used herein, may refer to one or more work units that may be executed to fulfill a work flow task associated with a work order. For example, a work unit may include an input and an output to permit a series of work units to form a processing path through which content may flow.

The term “work order,” as used herein, may refer to an order (e.g., associated with a customer) that is received for processing by the DDC. A work order may include a work flow, criteria for the selection of the content to be processed in the work flow, and the parameter values for the work units pertaining to the work flow. For example, the parameters may include system parameters that may not be changeable, default parameters that may be changeable, and default parameters that may require human intervention (e.g., user verification, user entry, etc.).

The term “work unit task,” as used herein, may refer to particular function or operation that may be performed based on a work unit. A work unit may perform one or more work unit tasks.

According to an exemplary scenario, assume that a user defines two work units via the DDC. Also assume that the first work unit describes reformatting an M×N video into a 600×400 video, and the second work unit describes inserting an advertisement into the video. When a customer (e.g., a content creator, a content provider, etc.) places an order with the user to reformat the video into a 600×400 video and insert an advertisement in the video, the user may compose, through a graphical user interface (GUI) provided via the DDC, a work flow by concatenating two or more work units. When the user submits a work order, the DDC may schedule for execution a set of tasks that are associated with the work units included in the work flow. The DDC may then perform the tasks. The preceding example is provided for simplicity. Descriptions below provide additional details with respect to the DDC.

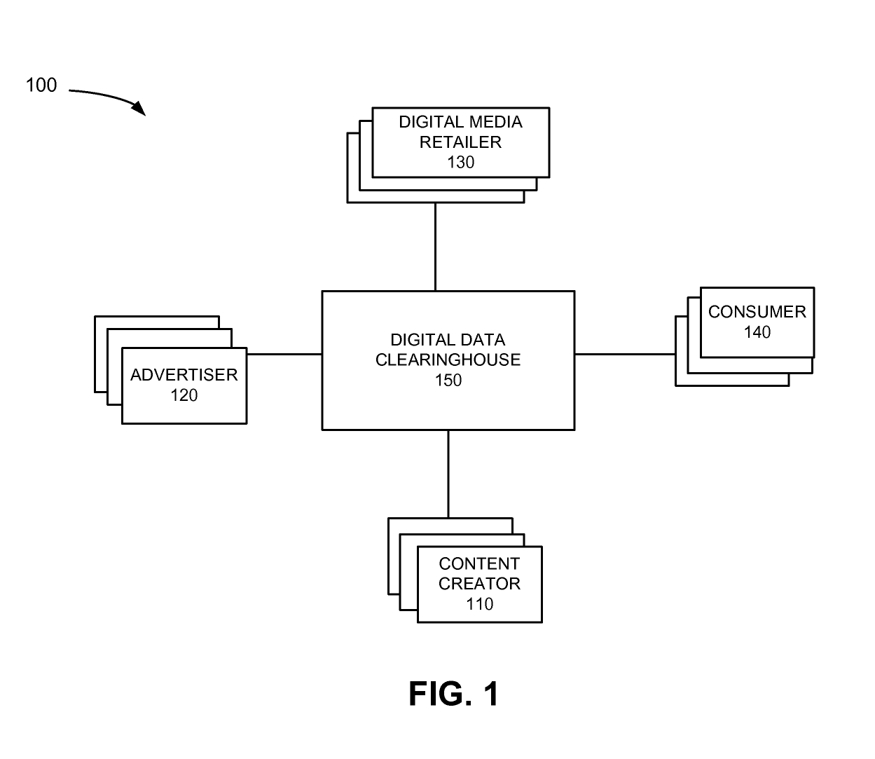

FIG. 1 is a diagram of an exemplary network 100 that includes a DDC for processing content. Referring to FIG. 1, network 100 includes one or more content creators 110, one or more advertisers 120, one or more digital media retailers (DMRs) 130, one or more consumers 140 and digital data clearinghouse (DDC) 150.

Content creator 110 (referred to collectively as content creators 110 or individually as content creator 110) may represent one or more creators of content that wish to package and/or distribute the content to other parties, such as consumers 140. For example, content creators 110 may include movie or television studios, music companies, publishers, game developers, parties who generate user-generated content (UGC), websites, blog sites, etc. Content creators 110 may provide content to DDC 150 for formatting (e.g., transcoding, etc.), packaging and/or distribution, as described further below.

Advertiser 120 (referred to collectively as advertisers 120 or individually as advertiser 120) may represent one or more parties that wish to insert advertising into content. For example, advertiser 120 may contract with a content creator 110 and/or digital media retailer 130 to insert an advertisement into a media stream provided to consumers 140. DDC 150 may insert the advertisement into the media stream in accordance with the agreement between the parties.

DMR 130 may represent one or more business entities that receive content from various parties and resell it to end users. For example, DMRs 130 may include broadcasters, cable companies, direct broadcast satellite (DBS) providers, Internet protocol television (IPTV) providers, mobile phone TV providers, online retailers, etc. DMRs 130 may receive content from DDC 150 and sell/provide the content to consumers 140.

Consumer 140 may represent one or more consumers 140 that receive content originally generated by or provided by content creators 110 and that has been processed by DDC 150. For example, DDC 150 may format and package the content for distribution by DMRs 130 and/or DDC 150 to consumers 140.

DDC 150 may include one or more devices (e.g., a server device, a computing device, etc.) for processing content. For example, as described above, DDC 150 may provide an automated environment in which content from content creators 110 is transformed and packaged for distribution in any number of formats, based on the particular requirements associated with DMRs 130. According to an exemplary embodiment, DDC 150 may also aggregate various data and insert advertisements into the content. DDC 150, consistent with embodiments described wherein, may also utilize flexible work flows to streamline the formatting and packaging of content for digital distribution.

According to other embodiments, network 100 may include additional devices, fewer devices, different devices, and/or a different configuration than those illustrated in FIG. 1. For example, network 100 may include a large number (e.g., hundreds or thousands) of different types of user device associated with consumers 140, such as, a mobile device, a stationary device, a handheld device, or a portable device. For example, the user device may include a television, a cellular phone, a computer (e.g., laptop, desktop, tablet, notebook, netbook, etc.), a personal digital assistant (PDA), a gaming device, a location-aware device, an Internet accessible device, etc. Additionally, or alternatively, according to other exemplary embodiments, network 100 may include additional DDCs 150, etc. Additionally, or alternatively, network 100 may include one or more networks of various types to interconnect the devices illustrated in FIG. 1 and enable the devices to communicate with one another. For example, network 100 may include a public switched telephone network (PSTN), a local area network (LAN), a wide area network (WAN), the Internet, an intranet, or some other type of network. Network 110 may include wireless connections and/or wireless connections among the devices illustrated.

Also, according to other embodiments, one or more functions and/or processes described as being performed by a particular device or component may be performed by a different device or component, or some combination of devices or components. Additionally, or alternatively, according to other embodiments, one or more functions and/or processes described as being performed by multiple devices or multiple components may be performed by different devices or components, or a single device, etc.

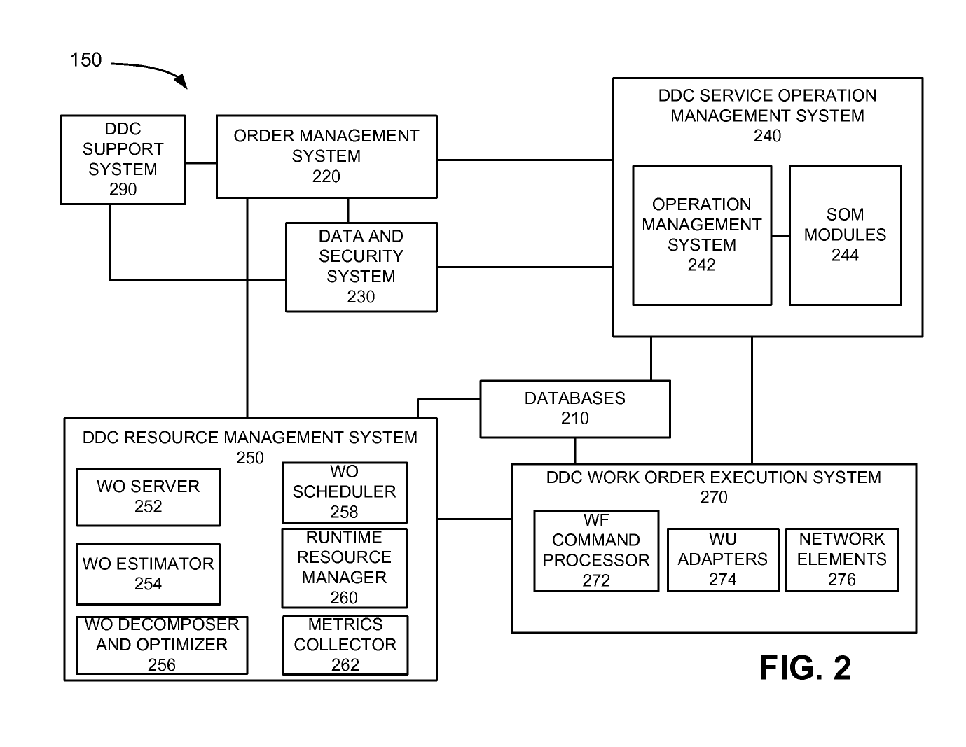

FIG. 2 illustrates an exemplary embodiment of DDC 150. Referring to FIG. 2, DDC 150 may include databases 210, order management system 220, data and security system 230, DDC service operation management system 240, DDC resource management system 250, DDC work order execution system 270, and DDC support system 290.

Databases 210 may store work unit definitions, work flows, parameters, tables, etc., that are associated with various devices, components, etc., in DDC 150, intermediate or end results of processing performed by different processes in DDC 150, etc.

Order management system 220 may include one or more devices (e.g., a server device, a computing device, etc.) for managing customer orders, generating reports, etc. According to an exemplary embodiment, order management system 220 may include client components that interface with components of DDC service operation management system 240. The client components (e.g., web browser) may receive customer orders, requests for reports, etc., and relay the received information to the components of DDC service operation management system 240 for the creation, validation, estimation, submission, approval, execution and reporting of activities associated with the customer orders, request for reports, etc. For example, a customer order may be completed by sending, to a component of DDC service operation management system 240, a selection of a particular work flow that will drive the processing of content associated with the order.

Data and security system 230 may include one or more devices (e.g., a server device, a computing device, etc.) to provide for authentication and authorization of users having roles in DDC 150 and/or for taking actions that are associated with the authorized roles (e.g., create user accounts, remove user accounts, generate an initial password, etc.). For example, when a user logs in as a DDC operator, the user may be authorized to design work units and/or compose work flows. According to an exemplary embodiment, data and security system 230 may interface with order management system 220, DDC service operation management system 240, and DDC support system 290.

DDC service operation management system 240 may include one or more devices (e.g., a server device, a computing device, etc.) to control an overall operation, configuration, and management of DDC 150. For example, DDC service operation management system 240 may include operation management system 242 and service operation management modules 244. Via a client component that communicates with operation management system 242, a user may control the configuration, administration and operation of DDC 150. For example, in one implementation, via a web browser or another client application, a user may control security, compose a work flow, administer accounts that are associated with content creator 110 or DMR 130, submit a work order, add data to storage of DDC 150, manage resources, manage DDC configuration (e.g., create a work unit), manage catalogs of content, run reports, monitor DDC work orders (e.g., information associated with a work order), etc.

In providing each of such services to a client, operation management system 242 may employ service operation management (SOM) modules 244. SOM modules 244 may include components that correspond to the above-listed services. For example, SOM modules 244 may include a security manager, a work flow manager, an account manager, a work order manager, a data and storage manager, a resource management module, a configuration manager, an asset management module, a catalog management module, a monitoring and reporting module, etc. DDC service operation management system 240 may further include a GUI for interfacing with SOM modules 244.

DDC resource management system 250 may include one or more devices (e.g., a server device, a computing device, etc.) that support the capacity management of resources associated with network elements (NEs) of DDC 150. As illustrated in FIG. 2, DDC resource management system 250 may include a work order server 252, a work order estimator 254, a work order decomposer and optimizer 256, a work order scheduler 258, a runtime resource manager 260, and a metrics collector 262.

Work order server 252 may provide work order-related interfaces to operation management system 242 and/or SOM modules 244, and may communicate with work order estimator 254, work order decomposer and optimizer 256, and work order scheduler 258 to submit, decompose, validate, and save work orders, and to estimate, schedule, and reserve resources during an order submission.

Work order estimator 254 may estimate the cost of completing a decomposed work order across work units of a work flow, based on resources that are associated with the work units for each resource type. Work order estimator 254 may store the cost in one of databases 210 in terms of resource capacity units (RCUs) and duration of time required to complete work unit tasks, sub-work unit tasks, processes, etc., which may pertain to the execution of the work order. The term “RCU”, as used herein, may include a unit of measure for a resource type. For example, an RCU may correspond to bits per second, tasks per hour, CPU processing time, etc., or some other type of quantity of unit (e.g., capacity unit) by time (e.g., a time unit, such as, hour, minute, second, millisecond, etc.), quantity of unit (e.g., gigabyte (GB) for storage, megabits for bandwidth, etc), etc.

Work order decomposer and optimizer 256 may break down an order into work units based on the work flow associated with the order. Furthermore, based on the decomposition, work order decomposer and optimizer 256 may generate work unit tasks, or simply “tasks,” assign work unit task parameters, create work unit task connectors, etc., which are described further below.

Work order scheduler 258 may match cost estimates for different resource types for a work order to available time slots in an allocation schedule across different network elements (e.g., hardware/software components that perform underlying operations for a work unit). As a result of the scheduling, work order scheduler 258 may output start and end times for each of the work unit tasks and for resource reservations.

Runtime resource manager 260 may allocate network elements/user groups to a process at the time of execution on behalf of a work unit. Runtime resource manager 260 may attempt to honor scheduled reservations of resources. However, if the resources are unavailable, runtime resource manager 260 may attempt to obtain replacement resources.

Metrics collector 262 may determine, for each work unit, actual time of completion and used/consumed resources associated with the execution of the work unit. Based on previous actual execution measurements, metrics collector 262 may modify factors that are used to estimate the resource and time necessary to complete a task associated with a work unit for a particular content.

DDC work order execution system 270 may include one or more devices (e.g., a server device, a computing device, etc.) to manage the flow and execution of work units of a defined work flow associated with a work order. DDC work order execution system 270 may include a work flow command processor 272, work unit adapters 274, and network elements 276. For simplicity, FIG. 2 does not illustrate other components of DDC work order execution system 270. For example, DDC work order execution system 270 may include a work unit processor (not illustrated). Depending on the implementation, DDC work order execution system 270 may include additional, fewer, or different components than those illustrated in FIG. 2.

Work flow command processor 272 may drive work order execution. According to an exemplary embodiment, work flow command processor 272 may include a work order manager, a work order processor, and a work unit processor (not illustrated). The work order manager may provide interfaces to resource management system 250 for initiating an execution of a work order, retrieving the status of the work order, suspending/resuming the work order execution, canceling the work order, etc. The work order processor may coordinate work unit tasks for completion of a work order. In coordinating different work unit tasks, the work order processor may sequence the tasks for optimum execution time and resource utilization. The work order processor may communicate with runtime resource manager 260 for allocation and de-allocation of resources. The work unit processor may dispatch processes/threads to perform a work unit task.

Work unit adapter 274 may include interfaces for adapting network elements to perform media content processing corresponding to a work unit. In one implementation, each work unit adapter 274 may be versioned and may include Java code. Each work unit adapter 274 may monitor the corresponding network element to prevent over-allocation of the network element, maintain normal execution of logic associated with the network element, and provide real-time information to metrics collector 262.

Network elements 276 may include physical or logical network devices/components for ingesting, transforming, and distributing content.

DDC support system 290 may include one or more devices (e.g., a server device, a computing device, etc.) and/or personnel to provide support services, such as creation of work units, composition of work flows, etc., billing support, contracting management, pricing, etc.

According to other embodiments, DDC 150 may include additional, fewer, different, and/or a different arrangement of devices than those illustrated in FIG. 2. The configuration shown in FIG. 2 is for illustrative purposes. In other configurations and/or implementations, functions that are associated with one component illustrated in FIG. 2 may be performed by one or more other components in FIG. 2; any of the components may be connected to any other of the components; and functions of one component may be included in another component. Accordingly, in the other configurations or implementations, DDC 150 may include additional, fewer, different, or a different arrangement of components than those illustrated in FIG. 2. For example, according to an exemplary embodiment, DDC resource management system 250 may include a component for providing reports on resources, schedules, metrics, etc.

As previously described, DMR 130 may represent one or more business entities, such as, for example, service providers, etc., that may receive content from various sources (e.g., DDC 150, advertiser 120, etc.) and provide the content to content users (e.g., consumers 140, subscribers, etc.). Content users may view the content on user devices. According to exemplary embodiments, a content manager may provide users (e.g., DMR users, etc.) the ability to manage content. The content manager is described further below.

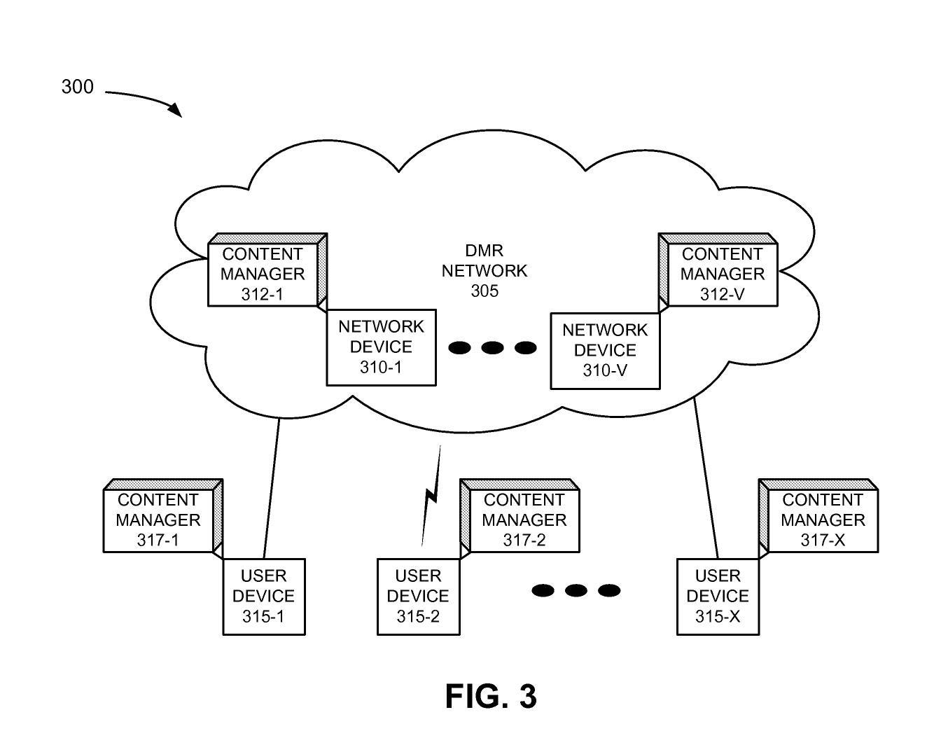

FIG. 3 is a diagram illustrating an exemplary environment 300 that includes an exemplary embodiment of a content manager. As illustrated, environment 300 may include a DMR network 305 that includes network devices 310-1 through 310-V. Network devices 310 may include corresponding content managers 312-1 through 312-V. Environment 300 may also include user devices 315-1 through 315-X. User devices 315 may include content managers 317-1 through 317-X.

DMR network 305 may include one or multiple networks of any type. For example, DMR network 305 may correspond to a WAN, a LAN, a metropolitan area network (MAN), a wireless network, a wired network, a Public Land Mobile Network (PLMN), a television network, the Internet, an intranet, and/or some other type of network. DMR network 305 may store or have access to content. As described herein, the content may be managed via user devices 315.

Network device 310 may include a device capable of communicating with devices, networks, systems, components, etc. For example, network device 310 may correspond to a computational device (e.g., a computer, etc.), a server device, a peer device, a routing device, and/or some other type of network device. Network device 310 may store and/or have access to content, which may be provisioned to content users (e.g., consumer 140, etc.). Content manager 312 may perform various functions and provide various services pertaining to the management of content. Content manager 312 is described further below.

User device 315 may include a mobile device, a stationary device, a handheld device, a tablet device, or a portable device. For example, user device 315 may correspond to a computational device (e.g., a desktop computer, a laptop computer, a palmtop computer, a notebook computer, a tablet computer, etc.), a communication device (e.g., a wireless phone, a wired phone, an Internet-access device, etc.), a data organizing device (e.g., a personal digital assistant (PDA), etc.), and/or some other type of user device. Content manager 317 may perform various functions and provide various services pertaining to the management of content. Content manager 317 is described further below.

The number of devices and networks, and configuration in environment 300 is exemplary and provided for simplicity. In practice, environment 300 may include additional devices, fewer devices, different devices, and/or differently arranged devices, than those illustrated in FIG. 3. For example, content manager 312 may be implemented in a centralized fashion (e.g., on a single network device 310) or as a cloud service that may be accessed by multiple users (e.g., DMR users (not illustrated)) via content managers 317 of user devices 315. Additionally, or alternatively, in practice, environment 300 may include additional networks and/or differently arranged networks, than those illustrated in FIG. 3. For example, DMR network 305 and/or user devices 315 may be communicatively coupled to networks associated with DDC 150, advertiser 120, etc. Also, one or more functions and/or processes described as being performed by a particular device may be performed by a different device, or some combination of devices, according to other embodiments.

Environment 300 may include wired and/or wireless connections among the devices illustrated. By way of example, the connections may include cable, fiber optic, wireless, etc. Additionally, environment 300 may operate according to one or multiple communication standards, protocols, etc.

As previously described, content manager 312 and content manager 317 may perform various functions and/or provide various services pertaining to the management of content. According to exemplary embodiments, content managers 312 of network devices 310 and content managers 317 of user devices 315 may communicate to permit users (e.g., DMR users) to manage content. By way of example, content manager 312 and content manager 317 (referred to collectively as content manager) may permit a user (e.g., a DMR user) to create content packages, create content bundles, add content, delete content, optimize prices pertaining to content, create promotions pertaining to content, monitor sales and revenue, monitor advertisement performance, monitor content consumption, etc. For example, a DMR user of user device 315-1, which includes content manager 317-1, may communicate with content manager 312-1 of network device 310-1 to manage content, as described herein. Content manager 317 may provide user interfaces (e.g., GUIs, etc.) to the DMR user to allow the DMR user to manage content.

According to an exemplary embodiment, the content manager may permit a DMR user to review summaries of the financial performance of content. In contrast to other conventional approaches, which may rely solely on estimations or forecasts, the financial performance summaries are based on real-time tracking information. For example, according to an exemplary embodiment, the content manager may perform real-time tracking of the purchasing and the viewing of content by content users (e.g., consumers 140, etc.). The real-time tracking may pertain to content users and content. For example, the real-time tracking pertaining to content users may include the tracking of real-time metrics associated with content user behavior (e.g., content purchased (e.g., content bought to own, content rented, etc.), content viewed, format of content (e.g., content with advertisements (ads), content without ads, content with replay capability, content without replay capability, etc.), content searched, content users' interaction with ads, content user's rankings of content, content user's recommendations of content to other content users, etc.), usage patterns (e.g., time of usage, frequency of usage, location of usage, content user device used, etc.), self-identified attributes (e.g., content user profile information (e.g., age, gender, etc.), content user preferences, content user-voting of content, etc.), other content users behavior (e.g., friends of the content user, other content users, etc.), velocity of purchasing over time pertaining to a particular content or group of content, etc.

According to an exemplary embodiment, the content manger may generate real-time tracking information based on the real-time tracking For example, the content manager may compile information obtained from the real-time tracking, format the information, and store the information so that the information may be used by the content manager, other devices in DMR network 305, other devices in network 100, etc. According to another embodiment, the content manager may receive real-time tracking information from other network devices (e.g., in DMR network 305, DDC 150, etc). The real-time tracking information may form a basis to create various categories or groupings of content users (e.g., individual, household, preferences to genre, by age, by education, all content users, etc.), examples of which are described further below.

Content users may purchase and view content across multiple user devices. For example, a content user may purchase content and view a portion of the content on his/her television, view another portion of the content on his/her handheld device (e.g., wireless telephone, etc.), and view a remainder of the content on his/her desktop computer. In this regard, the real-time tracking information may be based on a content user's behavior, usage patterns, etc., using multiple user devices. Additionally, the content user may be identified with respect to the purchasing and the viewing of content. For example, the content user may manually identify himself/herself (e.g., based on a log-in) before purchasing, viewing, etc., content, or may be automatically identified based on device identifiers (e.g., telephone number, Internet Protocol (IP) address, Bluetooth identifier, etc.), etc. In this regard, the real-time tracking information may include a level of granularity down to the individual or individual's user device and upward therefrom (e.g., a household of multiple content users, groups of content users sharing one or multiple demographics, etc.).

According to an exemplary embodiment of the content manager, financial performance summaries pertaining to content may include, for example, volume sold (e.g., year-to-date (YTD), previous YTD, percentage of change, etc.), net sales (e.g., YTD, previous YTD, percentage of change, etc.), margin dollars, and margin percent at multiple levels of granularity. By way of example, the levels may include all content, a particular genre of content (e.g., drama, comedy, adventure, horror, etc.), a package of content (e.g., content and metadata), a bundle of content (e.g., combinations of content, combinations of television channels, etc.), a-la-carte content (e.g., a television show, a summary or a recap of an episode, a movie, a portion of content (e.g., first 15 minutes of content, etc.)), a group of content users, a household of content user(s), a particular content user, etc.

In addition, for each level, the content manager may permit the DMR user to compare financial performance summaries against previous time periods (e.g., previous year, etc.), as well as current targets, current forecasts, etc. For example, according to an exemplary scenario, a DMR user may wish to view how a-la-carte drama content is performing versus its profit objective at a segment level, how the a-la-carte drama content compares to drama content overall, and how a-la-carte drama content compares to all content. Based on the financial performance summaries, the DMR user may notice that a-la-carte drama content is outperforming relative to expectations with respect to female content users within a particular age range, while with respect to female content users in another age range, it is underperforming to the extent that an overall performance of a-la-carte drama content is below expectations. The financial summaries may also include graphs pertaining to device/platforms (e.g., user devices) and various content user demographics (e.g., age, gender, income, education, ethnicity, location, etc.). For example, for a particular level of granularity (e.g., all drama), the financial summaries may include a graph that indicates the percentages of viewership distributed among various user devices, such as, 24% for television (high-definition), 21% for mobile (low-resolution), 24% for mobile (high-resolution), etc. Also, the financial summaries may include a graph that indicates that 26% of “soccer moms” view drama, while 47% of working retirees view drama. The financial summaries may also be filtered based on region, customer segment (e.g., demographics, such as age, etc.), or some other customizable parameter.

The financial summaries may also permit the DMR user to review the highest volume content (e.g., title of content, net sales, margin in dollars, margin in percentages, percentage to plan, etc.) and the lowest volume content based on genre, etc.

According to an exemplary embodiment, the content manager may permit a DMR user to review content performance. For example, the DMR user may obtain financial performance information pertaining to a particular content or some type of category relating to content (e.g., content creator, genre, etc.). The content manager may provide a GUI that displays a hierarchy of content and financial performance information (e.g., volume sold, net sales, margin dollars, margin percent figures, etc.) associated with each level of the hierarchy of content. For example, according to an exemplary scenario, a DMR user may navigate to a particular content entitled “A Dog Named Christmas.” A window may include cast information and a synopsis of the content. Additionally, the window may include when the title was added, a lifetime value, a popularity ranking compared to all content, a popularity ranking compared to other content in its genre, content user ratings, other ratings (e.g., an Internet Movie Database (IMDB) rating, etc.), and a recommendation success rate (e.g., 13%). The window may also include volume information pertaining to this title based on format (e.g., television high-definition, mobile low-resolution, etc.), with ads, without ads, bought, rented, etc. Also, the window may include a velocity chart associated with this content. Upon review of the financial performance information, the DMR user notices that the velocity chart indicates a steep downward trend in daily viewing over the past three months by male content users. The DMR user also discovers similar behavior by male content users with respect to other content of a similar genre (e.g., ABC-Hallmark content). Based on the performance information, the DMR user may proactively address deficiencies in performance of content. For example, the DMR user may take actions (e.g., reduce the price, bundle with other content, etc.) to improve content performance before the end of a financial period.

According to an exemplary embodiment, the content manager may permit a DMR user to add content. For example, the DMR user may add content (e.g., new releases, archived content, etc.) to be available for purchasing and viewing by content users. The DMR user may search for new content based on a keyword search. For example, according to an exemplary scenario, the DMR user may wish to add content similar to content that is currently performing well with a particular group of content users. For example, the genre of family drama may be doing well with certain content users and the DMR user decides to add additional content for this genre.

The DMR user accesses a catalog of content (e.g., associated with DDC 150). The DMR user begins a keyword search (e.g., Hallmark) and enters start and end dates. The DMR user may also add additional search criteria, such as, for example, runtime of content (e.g., 30-90 minutes, etc.), retail price (e.g., $1.00-$50.00, etc.), and cost to license (e.g., $100.00-$50,000, etc.). In response to the search, the content manager displays titles and images corresponding to the content found from the search. The content manager may also provide other information pertaining to each content, such as, for example, a synopsis of the content, attributes of the content, a preview of the content, cost to source/license the content, runtime, suggested retail price, release date, relevance to search terms, etc.

At the bottom of the screen, the content manager may also automatically recommend content based on aggregate volumes, heuristics, user behavior, etc., associated with the targeted group of content users and/or aggregate volumes, heuristics, user behavior, etc., associated with content users of other genres, across all content distributed by DMR network 305, etc. Additionally, according to an exemplary embodiment, the content manager may take into account the purchasing and viewing trends of users that may not be subscribers to DMR network 305. For example, the content manager may access DDC 150 and be provided with trends associated with other DMRs 130.

The content manager permits the DMR user to sort the search results of the content based on one or more sorting criteria (e.g., release date, popularity, relevance to other content, user rating, etc.). Based on the sorted content, the DMR user selects particular content and the content is automatically added to the hierarchy of content. The DMR user then assigns a price target for the newly added content. In this example, while the suggested retail price is $3.99, the DMR user sets the price to $3.79, and the content is made available to content users. The DMR user may also configure other options pertaining to the newly added content (e.g., buy with ads, buy without ads, buy, rent, etc.), as well as designate promotion type (e.g., bundle with another title, etc.), genre (e.g., family genre, etc.), and content user consumption habits (e.g., show to immediate matches only, show to close relatives, show across all consumption, etc.).

The content manager provides the DMR user with updated financial targets for the content category that is currently performing well and now includes the newly added content. The updated financial targets take into account the buying habits of the particular group of content users to forecast the volume and profitability of the newly added content. For example, the content manager may leverage sales history and forecasts from like content to assist in generating estimate figures pertaining to the newly added content and/or the content category. For example, the content manager may provide estimates pertaining to volume change, margin change, anticipated revenue, etc., based on the newly added content.

According to an exemplary embodiment, the content manager may permit a DMR user to create a content promotion. For example, a content promotion may include a price promotion (e.g., a reduction in price to buy or rent content), a bundling promotion (e.g., including one content with another content), a free-view promotion (e.g., permit content users to view content for free if they watch ads and take a survey), a buy one, get one free promotion, etc. The content manager may also permit the DMR user to enter or select parameters that may govern how and when the promotion may be implemented. For example, the DMR user may target particular content users (e.g., by gender, content viewing habits, genre preference, etc.). The content manager may also permit the DMR user to have the promotion dynamically inserted into any content being viewed by content users that satisfy the parameters associated with the promotion. Alternatively, the DMR user may configure the promotion to be presented to content users only when the content users do something (e.g., conduct a search, etc.) or view content that is similar to the promoted content and/or within a content category of the promoted content. The DMR user may also enter start and end dates for the promotion.

According to an exemplary embodiment, the content manager may recommend content promotions to a DMR user based on the real-time tracking information, targeted content user(s), DMR user's created content promotion, and/or purchasing and viewing trends. For example, DDC 150 may recognize trends, across all DMRs, in which content may be correlated to each other, and when bundled, may dramatically increase purchasing by content users. A recommended content promotion may also take into account the DMR user's financial performance goals. For example, the content manager may analyze the anticipated impact on key financial performance indicators (e.g., profit dollars, profit margin percentages, revenue, volume, etc.) in view of a promoted content.

According to an exemplary embodiment, the content manager may automatically select a content user to target for a content promotion based on real-time tracking information, a DMR user's created content promotion, and/or purchasing and viewing trends, etc. The content manager may assess content user behavior, which may indicate a positive or a negative trend pertaining to the purchasing and the viewing of content, and automatically select a content user to increase profit dollars, revenue, etc., and provide these content user(s) a personalized content provisioning service.

The content manager may permit the DMR user to view the performance of a specific content promotion and make real-time changes to maximize sales and margin. For example, the DMR user may vary the version of an ad based on location of the content user, content user behavior, etc.

According to an exemplary embodiment, the content manager may optimize pricing of content to maximize profitability and revenues for a given time period and/or pertaining to content users. For example, according to an exemplary scenario, a DMR user wishes to optimize prices and selects a manage prices option displayed by the content manager. The content manager automatically identifies a list of content (e.g., top 10) that are performing lower (e.g., in terms of volume, revenue, etc.) than expected targets. In this way, the ability of the DMR user to make optimal pricing decisions may be improved. Additionally, for example, if trends from the DMR user's analysis of global usage data, associated with DDC 150, suggests that volume, revenue, etc., and viewership are increasing quickly, the content manager may suggest a price increase and/or suggest to promote similar content in order to take advantage of the increased interest.

In this example, the DMR user selects content from the list. Upon selection, a dialog box appears and automatically suggests a price discount level of 30% for a particular segment of content users. The content manager also suggests other dynamic options, such as bundling the content with an e-book at a 15% discount off the total price of both items. Next to each option, the content manager displays the anticipated revenue, margin dollar, margin percentage, and volume impact based on the suggested changes. The DMR user selects the price discount options, and clicks on a confirm button to instantly change the price.

According to an exemplary embodiment, the content manager may calculate the price reductions based on demand forecasts, price elasticity, and the sales and margin objectives of the DMR. The forecasts, price elasticity factors, and the recommended bundles of content may be based on global usage data associated with the DMRs of DDC 150. For example, DDC 150 may provide data on the global price elasticity of a given title across all of the DMRs. This may assist the DMR user to understand the level of pricing and to decide an appropriate discount or mark-up. Additionally, the global usage data may enable clustering analysis to assist the DMR user in understanding which content are commonly purchased together. The content manager may offer the DMR user various flexibilities when assigning prices to content. For example, the DMR user may set a price for content in one region (e.g., ZIP code, etc.) to be different from another region. The content manager may permit the DMR user to make real-time changes to prices and allow the DMR user to adjust content offers, as needed, in view of changing user-demand of content.

According to an exemplary embodiment, the content manager may permit the DMR user to manage (e.g., arrange, prioritize, etc.) a planogram. For example, according to an exemplary scenario, a DMR user may wish to manage a planogram pertaining to a segment of content users. For example, the DMR user may want to adjust how content is presented to the segment of content users in order to improve sales, etc. The DMR user may select a manage planogram option and views the planogram pertaining to the segment of content users. The content manager may automatically suggest how a layout may appear, what content to promote, and how to arrange modules on the screen based on sales, margin performance, financial targets, sales velocity, content available, etc. In this example, with the upcoming holiday season, the DMR user has had his/her application developers create a special gifting module that permits users to gift content to a family member. In view of the holiday season approaching, the DMR user decides to insert the special gifting module in the planogram. The content manager then displays rules associated with the content (e.g., brand X cannot be merchandised next to Brand Y, media from content creator A always needs to be promoted over content creator Z, etc.). The DMR user further customizes and finalizes the planogram based on his/her strategies to make the planogram available to the segment of content users.

According to the above example, the content manager may offer the DMR user suggestions to a planogram based on templates, content user heuristics, content user behavior, etc. For example, the DMR user may understand that for a particular segment of content users, recommendations from friends may be more influential than content that is considered new and up-and-coming.

According to an exemplary embodiment, the content manager may provide dynamic price optimization features. For example, the content manager may maximize ad revenue and profitability based on trend and pattern recognition, and may automatically adjust pricing to proactively manage inventory availability.

According to an exemplary scenario, a DMR user may wish to improve sales and profitability of ad slots in content when there are sudden spikes of content user interest. In this example, the DMR user notices in the newspaper that a TV star has been receiving a great deal of publicity from a “60 Minutes” feature story. Additionally, a DMR yield management engine of the content manager may automatically recognize (e.g., based on the DMR user's settings) that content featuring the TV star, as well as ad sales appearing during the TV star's television show, have increased by 25% in the last two days relative to previous forecasts. Also, the DMR yield management engine may automatically recognize that an interest in the TV star has spiked above forecasted volumes, etc., and the ad inventory for the TV star content is more plentiful than anticipated at this time. Based on past ad performance data, sales, and profitability associated with the content, the DMR yield management engine calculates a new price elasticity for the ad slots and then modifies the price to maximize the revenue from the remaining ad slots. In this example, the DMR yield management engine may automatically increase ad slot prices for this content by an average of 40%.

The DMR user views a screen that lists the most recent pricing adjustments (e.g., both positive and negative) made by the DMR yield management engine, as well as other information, such as, demand change forecast and adjusted anticipated revenues. The DMR user clicks on the pricing adjustment to view graphs by type of ad (e.g., pre-roll spot, interactive bug, banner ad, post-roll spot, etc.) and by content title impacted that depict the increase or the decrease in demand versus forecast, adjustment to prices, and the anticipated revenue stemming from the change.

According to the above example, the DMR yield management engine may manage not only ad slots, but also the yields of demographics and specific target content users. For example, beyond simply adjusting prices for the ad slots associated with content, the DMR yield management engine may recognize increases in demand for a particular segment of content users in a particular geographic area. Based on such recognition, the DMR yield management engine may dynamically adjust ad prices and yields for that segment of content users to maximize ad revenue and profitability.

According to an exemplary embodiment, the content manager may provide real-time summary information pertaining to ad sales performance and inventory availability. For example, according to an exemplary scenario, a DMR user may wish to evaluate ad performance for all contracts to make sure each commitment is being met, make-goods are minimized, and that the DMR yield management engine is constantly optimizing ad placement for the highest utilization and profitability possible. The DMR user may be presented with an advertising sales management console that displays a summary of ad sales figures, a net number of impressions served, average cost-per-thousand (CPM), cost-per-action (CPA), and cost-per-engagement (CPE) achieved for a period of time. The DMR user is also able to view a comparison of ad sales performance with other time periods (e.g., last year, etc.), as well as comparisons with performance targets established for each ad sales metric.

The DMR user may view ad inventory performance, including impressions, utilization rate (e.g., rate at which available slots were filled), sales figures (e.g., revenue, average CPM, average CPE, volume, etc.) by the different types of slots available (e.g., first position versus second position, etc.), and types of ads (e.g., pre-roll, post-roll, banner ad, etc.). Additionally, the DMR user may view remnant information that may include rates at which ads were used to fill remnant slots and average remnant slot CPM, etc.

The DMR user may also review contracts which have been recently fulfilled and contracts that may be at-risk due to low fulfillment rates in comparison to total possible impression opportunities and timeframe remaining Additionally, the DMR user may access other advertising management tools, such as ad package definition, contract fulfillment, and ad payment reconciliation.

According to an exemplary embodiment, the content manager may dynamically create ad packages. For example, the content manager may dynamically develop and promote ad package opportunities to DMR users to increase returns of ad inventory. For example, according to an exemplary scenario, a DMR's clients are purchasing ads through their own advertising interface with the DMR, such as, buying specific shows or doing advanced audience targeting to specific demographic characteristics the client wants to reach. However, a DMR user may want to be able to package available ad inventory (also known as remnant advertising) to sell to his/her clients, as well as to maximize ad inventory utilization and profitability.

Given the above, the DMR user clicks on a define advertising package tab located in a summary dashboard screen. The DMR user is able to view the most recent content titles that have sold and slots that still have not sold. According to an exemplary embodiment, the content manager may automatically suggest buy-packages that include combinations of unsold ad inventory, which the DMR user may promote to his/her clients and/or media buyers. For example, the content manager may analyze metadata associated with remaining ad content and/or demographics to identify common themes or attributes (e.g., genre, actors, etc.) across the content to create dynamic ad-buy packages. For example, if the remaining ad inventory happens to share a common subject matter (e.g., Oprah) with content, the content manager may suggest a package of Oprah ad spots. The content manger may determine common subject matter based on metadata associated with each unsold ad and content with unsold slots.

In this example, the DMR user may be presented with multiple suggestions for ad packages. For example, the content manager may display a list of titles and projected CPM for an ad package. The list of titles includes Iron Man, Star Trek, Kevin Costner, Motorcycles, and Oprah. The DMR user reviews the suggested Oprah package. The content manager may generate the following packages pertaining to an Oprah book, such as, a thirty-second spot during the “Oprah Winfrey show,” a banner ad during an Oprah television special, a 5-second spot during “All My Children,” a 15-second spot during the “Tyra Banks Show,” an interactive bug when content users search for “Oprah” content, and an interactive bug during a “60 Minutes” interview with Oprah. The content manager may also list, for each ad, the duration for each ad slot (e.g., one week, etc.), a position (e.g., show opening, break 3, position 1, etc.), a forecast of impressions, and a target number of impressions. In this example, the DMR user names the ad package the “Oprah Plus Package” and confirms the ad package creation to make the ad package available for purchase (e.g., by media buyers, etc.).

According to an exemplary embodiment, remnant advertising, which is often a hindrance to ad sales executives, may be dynamically packaged in multiple ways. For example, based on the metadata, the content manager may identify common traits among ads. The content manager may then provide compelling value propositions to DMR users based on common promotional themes, genres, actors, affinity groups, demographics, and/or geographies. In this way, for example, media planners may be able to purchase these types of filler packages or dynamically formulate remnant ad packages close to the expiration of ad slots. For example, the media planners may learn about these new ad packages by e-mail, text messages, etc., to allow the DMR to market targeted packages to the media planner, as well as facilitate content and targeted audience ad-buys initiated by the media planners.

According to an exemplary embodiment, the content manager may identify contract fulfillment issues and address contract compliance risks. For example, according to an exemplary scenario, a DMR user may want to review the performance of an advertising contract, which one of his/her clients (e.g., one of his/her media planner clients) purchased, in order to track whether advertising goals will be fulfilled (e.g., impression and engagement targets met, etc.). In this example, assume that the DMR user's client purchased the “Oprah Plus Package” for a series of household cleaner ads.

The DMR user notices in his/her list of at-risk contracts that his/her client's campaign using the “Oprah Plus Package” will likely fall short of reaching its desired number of impressions. The DMR user clicks on an ad contract link, which then shows him/her a campaign detail screen outlining, for example, what ads are loaded and active for the campaign (e.g., one thirty-second spot, one banner ad, one adWord ad, an interactive bug ad, etc.), the number of impressions for each ad, the number of avails (e.g., ads available) purchased for the campaign, how many avails have been placed, the number of banner ads purchased and the number of click-throughs generated, the number of impressions registered overall versus campaign targets, the quality of the impressions (e.g., percentage of ads that were fast-forwarded, percentage of ads that were watched to the end, percentage of ads that were clicked on, etc.), and cost categories (e.g., cost per action, cost per engagement, cost per interaction, current CPM, target CPM, total budget for campaign, etc.).

Based on the above information, the DMR user may decide to increase the total number of impressions by temporarily expanding the campaign to other Oprah-oriented content not included in the first package buy. The DMR user may then rely on the intelligence of the content manager to help him/her optimize where the additional ad slots may be found to help meet the campaign targets, at a minimum opportunity cost. For example, the DMR user may select an auto-fulfill campaign option. The content manager may automatically place ads in content that are anticipated to drive the impressions needed to meet the campaign goals while also preserving priority, in-demand slots, to provide higher revenue advertising.

As previously described, advertiser 120 may represent one or more business entities, such as, for example, service providers, advertising departments, advertising agencies, media departments, etc., that may want to insert advertising into content. Content users (e.g., consumers 140, etc.) may view the ads and content on user devices. According to exemplary embodiments, an advertiser manager may provide users (e.g., ad users, media planners, etc.) the ability to manage advertising. The advertiser manager is described further below.

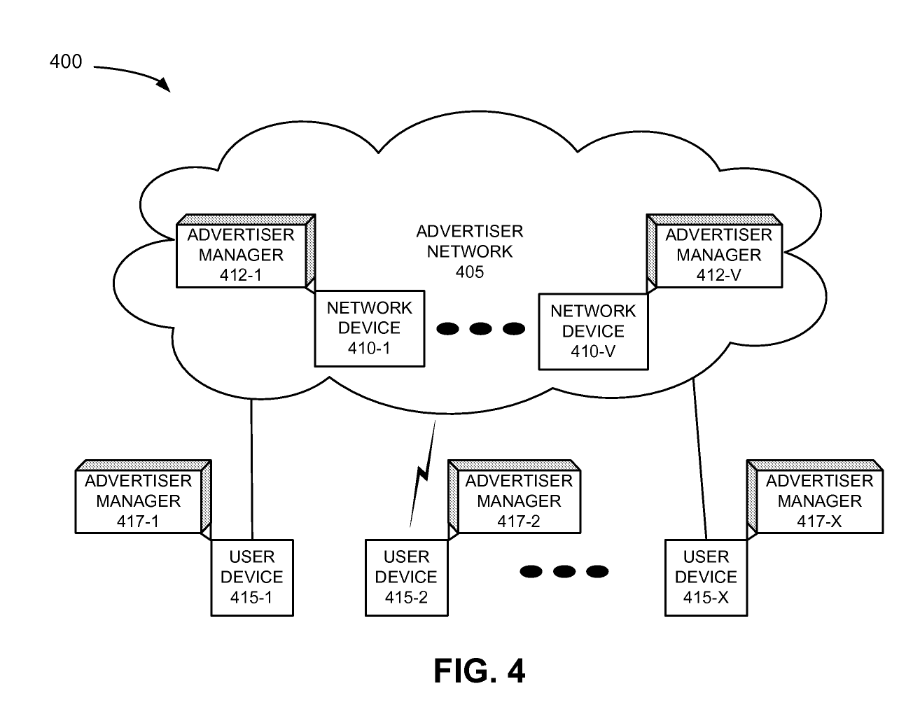

FIG. 4 is a diagram illustrating an exemplary environment 400 that includes an exemplary embodiment of an advertiser manager. As illustrated, environment 400 may include an advertiser network 405 that includes network devices 410-1 through 410-V. Network devices 410 may include corresponding advertiser managers 412-1 through 412-V. Environment 400 may also include user devices 415-1 through 415-X. User devices 415 may include coresponding content managers 417-1 through 417-X.

Advertiser network 405 may include one or multiple networks of any type. For example, advertiser network 405 may correspond to a WAN, a LAN, a MAN, a wireless network, a wired network, a PLMN, a television network, the Internet, an intranet, and/or some other type of network. Advertiser network 405 may store or have access to ads and/or content. As described herein, the ads may be managed via user devices 415.

Network device 410 may include a device capable of communicating with devices, networks, systems, components, etc. For example, network device 410 may correspond to a computational device (e.g., a computer, etc.), a server device, a peer device, a routing device, and/or some other type of network device. Network device 410 may store and/or have access to ads, which may be provisioned to content users (e.g., consumer 140, etc.) (not illustrated). Advertiser manager 412 may perform various functions and provide various services pertaining to the management of ads. Advertiser manager 412 is described further below.

User device 415 may include a mobile device, a stationary device, a handheld device, a tablet device, or a portable device. For example, user device 415 may correspond to a computational device (e.g., a desktop computer, a laptop computer, a palmtop computer, a notebook computer, a tablet computer, etc.), a communication device (e.g., a wireless phone, a wired phone, an Internet-access device, etc.), a data organizing device (e.g., a PDA, etc.), and/or some other type of user device. Advertiser manager 417 may perform various functions and provide various services pertaining to the management of ads. Advertiser manager 417 is described further below.

The number of devices and networks, and configuration in environment 400 is exemplary and provided for simplicity. In practice, environment 400 may include additional devices, fewer devices, different devices, and/or differently arranged devices, than those illustrated in FIG. 4. For example, advertiser manager 412 may be implemented in a centralized fashion (e.g., on a single network device 410) or as a cloud service that may be accessed by multiple users (e.g., ad users (not illustrated)) via content managers 417 of user devices 415. Additionally, or alternatively, in practice, environment 400 may include additional networks and/or differently arranged networks, than those illustrated in FIG. 4. For example, advertiser network 405 and/or user devices 415 may be communicatively coupled to networks associated with DDC 150, DMR 130, etc. Also, one or more functions and/or processes described as being performed by a particular device may be performed by a different device, or some combination of devices, according to other embodiments.

Environment 400 may include wired and/or wireless connections among the devices illustrated. By way of example, the connections may include cable, fiber optic, wireless, etc. Additionally, environment 400 may operate according to one or multiple communication standards, protocols, etc.

As previously described, advertiser manager 412 and advertiser manager 417 may perform various functions and/or provide various services pertaining to the management of ads. According to exemplary embodiments, advertiser managers 412 of network devices 410 and advertiser managers 417 of user devices 415 may communicate to permit users (e.g., advertiser (ad) users) to manage ads. For example, an ad user of user device 415-1, which includes advertiser manager 417-1, may communicate with advertiser manager 412-1 of network device 410-1 to manage ads, as described herein. Advertiser manager 417 may provide user interfaces (e.g., GUIs, etc.) to the ad user to allow the ad user to manage ads. By way of example, advertiser manager 412 and advertiser manager 417 (referred to collectively as advertiser manager) may provide advanced media planning functionality (e.g., target micro-audiences (e.g., at an individual level, at a particular location in a household (e.g., bedroom, kitchen, family room, etc.), at a household level, etc.), present available inventory, provide selections pertaining to ad placement, provide selections for type of ad, provide automated audience targeting functionality, provide automated ad campaign suggestion functionality, provide real-time reporting of ad campaign performance, and provide for real-time ad campaign modifications.

According to an exemplary embodiment, the advertiser manager may permit an ad user to customize his/her experience based on personalized access and personalized settings, and provide access to availability information, campaign management information, and account information. Additionally, the advertiser manager may permit the ad user to monitor current campaigns, receive recommendations on content which may be appealing to their target audiences, purchase additional avails for current campaigns, create new campaigns, and manage billing, payment, and account information.

According to an exemplary scenario, an ad user logs-in to the advertiser manager. The advertiser manager may display to the ad user links for all active client accounts. For example, the ad user may navigate to a link for managing customers, a link pertaining to contacts ending soon, a link to manage assets, a link to manage payments and accounts, a DMR's most popular and featured programming section, news regarding upcoming programming events, ad inventory still available, asset alerts (e.g., alerts indicating ads that may be under-performing), comparisons of performance (e.g., by year) for each client, and links to articles on successful ad campaigns.

According to this scenario, the ad user is acting on behalf of a client to place ads across various content and various user devices. For example, assume that the ad user receives a client request to expand an Oprah biography campaign. In response to the client's request, the ad user selects his/her client's account and a screen is displayed that includes the client's company name and primary contacts and contact information associated with the client. Below the client summary data, campaigns in-progress data for this client are displayed. For example, the campaigns in-progress data may include for each campaign, a campaign name, a description of the campaign, a start date, an end date, a performance measurement against a target performance (e.g., in terms of percentage, percentage of target impressions achieved, etc.), a detail button (e.g., to access more details pertaining to the campaign), an edit campaign button (e.g., to edit the campaign), and a view reconciliation button (e.g., to view invoices, etc.). The campaign in-progress data may also permit the ad user to view, for example, CPE, CPM, etc, pertaining to each campaign. The campaign in-progress data may also include a define new campaign button to permit the ad user to create a new campaign. In this way, the ad user may navigate to see the progress and status of his/her client's campaign which provides the ad user valuable insight as he/she proceeds to fulfill his/her client's request.

According to an exemplary embodiment, the advertiser manager may provide advanced media planning functionality. For example, the advertiser manager may permit an ad user to target audiences (e.g., at an individual level, a household level, etc.), provide recommendations of ad packages, and permit the ad user to create ad packages based on time-shifted content. For example, according to an exemplary scenario, assume the ad user wants to respond to his/her client's request to expand an Oprah biography campaign. For example, the ad user selects a specific program in which to promote a book. Also, the ad user will use the advertiser manager to design a campaign for him/her with content selected to best reach the desired target audience.

In this example, the ad user decides to purchase advertising slots pertaining to a specific “60 Minutes” episode mentioned to him/her by the client. The ad user types “60 Minutes Oprah” into a search box on a client view screen. In response to the search, the advertiser manager displays all “60 Minutes” episodes that feature a story about Oprah. For example, the search results include the title of each episode, a description of the episode, and the air date. The ad user clicks on one of the search results corresponding to the most recent episode and the ad user is presented with a pop-up window snapshot of information most relevant to him/her (e.g., set by user preferences), including run time, number of views per week across formats, average age of viewer, and average income of viewer. At the bottom of the pop-up window is a button to create a placement. The ad user clicks on the create placement button and is navigated to an inventory availability page, which includes a menu of available inventory (also known as avails) specific to that piece of content and at the top of the inventory availability page are two date boxes for input of a start date and an end date.

The menu presents the avails in a vertical list, by avail name, by avail type, and by avail position. There is also an availability button for each avail. The avail types may include, for example, an in-stream video, a companion banner ad (e.g., a watermark, an overlay, a bug, a banner, etc.), an opening slate (e.g., before content (e.g., content sponsored by, etc.), a branded player skin, and an interactive bug (e.g., an interactive ad, interactive ticker, interactive overlay, etc., that may be interactive with a user). The avail positions may include, for example, pre-roll (e.g., before content), mid-roll (during content based on trigger events occurring within the content, etc.), post-roll (after content), in-stream video only (e.g., displayed during an in-stream video), and requested video (e.g., displayed during a requested video, such as video-on-demand). The availability button may indicate whether an avail is sold out, already being used (e.g., selected), or available (e.g., select).

In this example, the vertical list includes avails of in-stream video types at pre-roll, mid-roll, and post-roll positions, companion banner ad types at in-stream video and requested video positions, an interactive bug type at a requested video position, an opening slate type at a pre-roll position, a branded player skin type, and interactive bug types at in-stream video ad only requested video positions. The branded player skin type may provide a customized screen (e.g., border, etc.) that may be based on a particular theme associated with a particular content, a genre of content, etc. For example, if a content user decides to view the movie “Avatar,” the branded player skin may include theme-based ad screens pertaining to the movie “Avatar.”

Based on the avails listed, the ad user reviews a-la-carte options of content and decides to purchase two weeks of an in-stream video ad in the pre-roll position, and a companion banner ad, which may be displayed during the entire video. The ad user selects the two ad options (e.g., via the availability buttons) and a total campaign price is displayed. The price changes dynamically with each click (e.g., $4000.00 after the first ad option is selected, and $5000.00 after the second ad option is selected). The ad user clicks on a reserve placement button to reserve the order.

Next, a pop-up window appears featuring a recommended sponsorship package for that particular “60 Minutes” episode that may maximize the ad value by offering the following: two weeks of a 30-second in-stream video spot inserted at the mid-point of the video, two weeks of a companion banner ad running at the top of the screen during the video, two weeks of an interactive bug, and two weeks of contextual links placed on mentions of “Oprah” and “biography” in content user forums, content user comments, and content user recommendations. The total campaign price would be increased to $6000.00. However, the offer includes a 25% discount. The pop-up window also indicates projected impressions (e.g., 800,000) and projected CPM (e.g., $7.50). The ad user likes the recommended sponsorship package offer and accepts the offer by clicking on a use recommendation button, which permits the advertiser manager to auto-configure the campaign.

According to an exemplary embodiment, the advertiser manager may provide automated audience targeting. For example, the advertiser manager may assist an ad user in targeting and reaching a niche audience and increase content user engagement by offering advertising that may appeal to their interests and preferences. For example, according to exemplary scenario, the ad user wants to define a new campaign to promote an Oprah book. The ad user selects the define new campaign button and a window is displayed. The window includes various tabs, such as, for example, an auto-suggest tab, a campaign information tab, an assets tab, a demographics tab, a usage habits tab, a user interests and affiliations tab, and advanced tab. The window also includes a total campaign cost option, which initially is set to $0.00.

According to an exemplary embodiment, each asset (e.g., ad) may be coded with metadata that pertains to the content of the ad (e.g., product, etc.) and content users. For example, the metadata may include a brand of product, type or category of product, product attributes, cost of product, geographic target of product, key words, and content user demographic information. The content user demographic information may be derived from user profiles, which may be set-up when a content user registers with a DMR. The content user demographic information may form a basis in which the advertiser manager may recommend a campaign that optimizes both a DMR's available inventory and an advertiser's available inventory.

The auto-suggest tab may permit the ad user to let the advertiser manager suggest a target demographic for his/her client's message based on the metadata and content user demographic information (e.g., stored by a DMR). The campaign information tab may display general information pertaining to a campaign, such as, for example a campaign name, a campaign description, and start and end dates. The asset tab may display a list of assets (e.g., Oprah Bio 30-second ad, an Oprah banner ad, etc.). The asset tab may also display for each asset, a preview of the asset, a production date, and a device/platform identifier (e.g., for television, for computer, for mobile, etc.).

In this example, the ad user decides to create and define his/her own demographic for a new campaign instead of using the auto-suggest feature of the advertiser manager. The ad user clicks on the campaign information tab and names the new campaign “Oprah Expansion.” The ad user also defines a start date and an end date. Next, the ad user clicks on an add asset button and a drop-down menu is displayed that lists the assets, such as, Oprah Bio 30-second, Oprah Bio 15-second, Oprah banner, Oprah bug, and all assets. In this example, it may be assumed that the assets have been previously uploaded (e.g., by the ad user, an ad agency, the client, etc.). These assets may be stored by the DMR and are accessible to ad users to be used in one or multiple campaigns.

The ad user selects the all asset option and a table is populated with all assets from the drop-down menu. The window also displays that the total campaign cost is $5,000.00. Next the ad user selects the demographics tab and the ad user is presented with a sliding bar with two selectors that permit the ad user to adjust an age range he/she would like to target. Additionally, there are boxes pertaining to gender and ethnicity. In this example, the ad user selects an age range from 35 years old to 55 years old. The ad user also selects female and no preference for ethnicity. The total campaign cost now totals $7,500.00. The demographics tab also permits the ad user to select a target audience based on education and income. For example, the ad user selects college and advanced degree, and also selects an income of $55,000 or greater. The total campaign cost is automatically adjusted to $9,500.00. Next, the ad user selects a geographical area to target. For example, the geographical area may include nationwide or the ad user may specify a particular state, ZIP code, designated market area (DMA), region, etc. In this example, the ad user selects nationwide so as to reach the broadest possible audience. The total campaign cost remains the same.

The ad user now selects the advanced tab. The advanced tab provides drop-down menus titled program title, subject, and program type, and each drop-down menu has a frequency drop-down menu. In this way, the ad user may define usage patterns for the campaign. In this example, the ad user selects “The Oprah Winfrey Show” from the program title drop-down menu and “2+ times per week” from the frequency drop-down menu. The total campaign cost is now $11,000.00.

The ad user also checks a box titled serve based on usage patterns. Based on this selection, an advertising campaign may be matched to the target audience based on heuristics and//or other algorithms. For example, target individuals may be identified based on their historical content choices, viewing patterns, community affiliations, and/or membership to social networks. By serving the advertising campaign based on usage patterns, response and performance may be improved, while minimizing non-targeted content users. For example, if a content user watches an ad similar to the ad user's ad, and the content user provides a positive rating, simply watches the ad to the end, etc., the DMR, via the advertiser manager, may place the ad user's ad in a queue to be served to that content user during an available time slot. In this way, the content user may be targeted not just based on the product being advertised, but also based on the style, quality, etc., of the ad itself. The determination of similarity between the ad the content user watched and the ad user's ad may be based on the metadata associated with the ads. Based on the checking of box titled serve based on usage patterns, the total campaign cost increases to $12,500.00. The ad user clicks on a create campaign button, and the window closes.

According to an exemplary embodiment, the advertiser manager may provide for bulk-ad purchasing and micro-ad purchasing (e.g., at an individual level, at a household level, etc.), along with providing automated campaign design options and interface functionality with interactive advertising networks. For example, when assets may be loaded into an automated campaign, an ad serving engine may automatically match an ad to a piece of content, a search, a forum comment, or a particular demographic based on keywords included in the metadata. This automation may permit interactive ad networks, like Google AdSense, to place ads with the DMR. For example, a campaign may operate similar to a search engine advertising campaign. The advertiser manager may also provide for micro-ad purchasing that may permit the tailoring of an ad placed, at an individual level, a household level, a set-top box level (e.g., a particular location in a household (e.g., bedroom, family room, etc.) that has a set-top box associated with one or more individuals), etc., in real-time, based on content user data. Since metadata associated with an ad may enable an ad serving engine to recognize, for example, that a product being advertised is a book, each ad may feature the name and address of the nearest bookstore to the content user.

According to an exemplary scenario, the ad user checks on the progress of the “Oprah Automated” campaign. The ad user is presented with a campaign detail screen, which includes multiple modules, such as, for example, demographics pertaining to the campaign (e.g., region, gender, age group, education level, income, etc.), financial data (e.g., CPM, CPE, CPA, etc.), and what assets are loaded and active for the campaign (e.g., one 30-second spot, one 15-second spot, three 5-second spots, one companion banner, one interactive bug, etc.). The campaign detail screen may also include the number of impressions registered for each asset, the target number of impressions for each asset, and the device/platform associated with the asset (e.g., type of user device (e.g., television, mobile, etc.). The campaign detail screen may also include the keywords associated with each asset (e.g., populated from metadata) and their respective effectiveness (e.g., 25%, 82%, etc.). In this example, the keywords may include Oprah, book, biography, and scandal. The campaign detail screen may also include graphs reflecting information pertaining to quality of impressions (e.g., percentage of target demographics, percentage of ads watched completely, percentage of fast-forwarded ads, or other content user behavior pertaining to the ad), number of actions by device (e.g., mobile, personal computer, the Web, television, etc.), and key performance indicators (e.g., percentage of ads completed, percentage of packages sold versus targeted, percentage of return on investment (ROI), etc.).

Further to the scenario, at the top of the campaign detail screen, is an edit campaign button. The ad user clicks on the edit campaign button and a pop-window appears titled edit campaign. The ad user clicks on the advanced tab. The advanced tab includes a check box labeled enable geographic micro-versioning. The ad user checks the box.

According to an exemplary embodiment, the advertiser manager may provide real-time reporting of performance, which may permit an ad user to make real-time adjustments to a campaign depending on a current state of the campaign. For example, according to an exemplary scenario, the ad user decides to review the status of the “Oprah Biography” campaign to see how the campaign is progressing as the end date approaches. The ad user navigates to a campaign detail screen that includes multiple modules including, for example, what assets are loaded and active for the campaign (e.g., one 30-second spot, one 15-second spot, one 5-second spot, one banner ad, etc.); the number of impressions of each; demographic information of the targeted audience; placements planned for the campaign and how many have been placed; number of banner ads purchased and number of click-throughs received; number of impressions targeted and registered (if applicable), such as, for example, by device, by platform, by type of spot, by demographic, by locality, and by interest group; quality of impressions (e.g., percentage in the target demo, percentage of ads that were fast-forwarded, percentage of ads that were watched to the end, etc.); and conventional and advanced financial data including, for example, CPM, CPE, CPA, total budget, etc.

At the top of the campaign detail screen, an alert box appears notifying the ad user that the 30-second video asset is under-delivering on quality impressions. For example, the advertiser manager indicates that the percentage of 30-second spots that have been fast-forwarded through is abnormally high (e.g., greater than 50%). While this type of information is typically not provided (e.g., real-time reporting of performance) by other conventional systems, according to an exemplary embodiment of the adverting manager, the ad user may make adjustments to a campaign that is underperforming based on the real-time performance detection and reporting. For example, the campaign detail screen includes an edit campaign button. Based on the above, the ad user decides to click on the edit campaign button to make some edits to the campaign.

The advertiser manager has the capability to suggest refinements to the campaign. For example, the ad user may be able to sign-up for automatic, mid-flight adjustments to a campaign based on real-time data received by the DMR by accessing the auto-suggest tab. In this example, however, the ad user decides to switch out the 30-second, in-stream video ad with a 15-second ad. For example, the ad user believes that using a shorter ad may improve the quality of the impressions and number of ads watched to the end.

The ad user clicks on an asset tab that lists three assets, such as, Oprah Bio 30-second, Oprah banner, and Oprah bug. The ad user highlights the Oprah Bio 30-second asset and clicks on a remove asset button. The ad user then selects Oprah Bio 15-second asset, clicks on an add asset button, and then clicks on a save changes button.

The ad user also decides that he/she needs to capitalize on the exposure provided by the “60 Minutes” episode about Oprah. The ad user decides to also modify the target audience. For example, the ad user navigates to the demographic tab. The ad user adjusts an age slider to an age range of 35 years old through 65 years old.

In view of this exemplary scenario, the ad user may react to real-time audience data and make real-time adjustments to a campaign. In this way, the ad user may closely monitor the progress of the campaign based on various performance metrics and proactively adjust the campaign in order to best serve his/her client.

According to an exemplary embodiment, the advertiser manager may provide automated billing, payment, and reconciliation. For example, according to an exemplary scenario, the ad user would like to view the invoices for his current campaigns in preparation for his/her conversation with a client. The ad user clicks on a view invoice button associated with the “Oprah Biography” campaign. The invoice is displayed that includes an invoice interface, a payment interface, and an account credit interface. These interfaces permit the ad user to manage the invoice, payment, and reconciliation of the campaign.

The invoice includes, for example, customer information, campaign data, and actual data to date. The campaign data may include, for example, name of the campaign (e.g., Oprah Biography), length (e.g., two weeks), price (e.g., $15,000.00), target impressions in target demographic (e.g., one million), and target CPM (e.g., $15.00). The actual data to date may include, for example, actual impressions (e.g., 1.2 million), actual impressions in target demo (e.g., 920,000), and actual CPM (e.g., $16.30).

The ad user clicks on a pay now button within the campaign invoice, and a confirmation window appears with the campaign name, payment amount, and a click-to-confirm payment button. The ad user now is ready to call his/her client and discuss detailed campaign progress information. At the conclusion of the campaign, reconciliation may be transparent and automated. A make-good may be offered in the form of an extra run of an ad when, for example, a DMR does not deliver the audience size or composition. The advertiser manager may automatically credit the advertiser's account with the make-good and give the advertiser the control to use/apply the credit where needed.

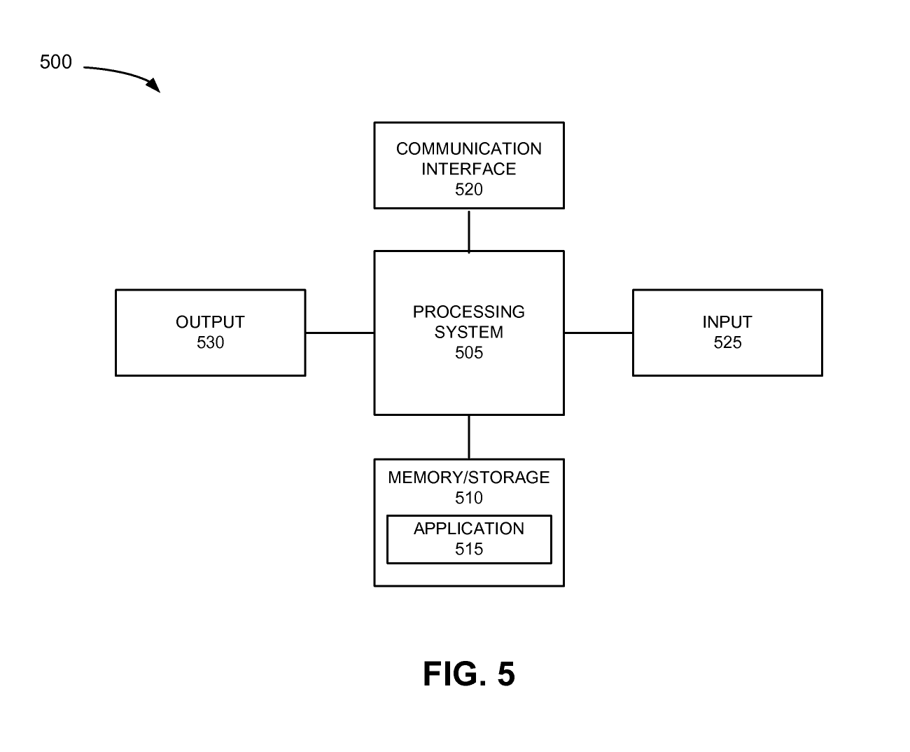

FIG. 5 is a diagram illustrating exemplary components of a device 500 that may correspond to one or more of the devices in network 100, environment 300, and environment 400. For example, device 500 may correspond to one or more devices pertaining to DDC 150, as well as one or more devices pertaining to content creator 110, advertiser 120, digital media retailer 130, consumer 140, network device 310, network device 410, user device 315, and/or user device 415.

As illustrated, according to an exemplary embodiment, device 500 may include a processing system 505, memory/storage 510 including an application 515, a communication interface 520, an input 525, and an output 530. According to other embodiments, device 500 may include fewer components, additional components, different components, and/or a different arrangement of components than those illustrated in FIG. 5 and described herein.

Processing system 505 may include one or multiple processors, microprocessors, data processors, co-processors, application specific integrated circuits (ASICs), controllers, programmable logic devices, chipsets, field programmable gate arrays (FPGAs), application specific instruction-set processors (ASIPs), system-on-chips (SOCs), and/or some other component or logic that may interpret and/or execute instructions and/or data. Processing system 505 may control the overall operation or a portion of operation(s) performed by device 500. Processing system 505 may perform one or multiple operations based on an operating system and/or various applications (e.g., application 515). Processing system 505 may access instructions from memory/storage 510, from other components of device 500, and/or from a source external to device 500 (e.g., a network, another device, etc.).

Memory/storage 510 may include one or multiple memories and/or one or multiple other types of storage devices. For example, memory/storage 510 may include a random access memory (RAM), a dynamic random access memory (DRAM), a read only memory (ROM), a programmable read only memory (PROM), a flash memory, a phase-change memory (PCM), and/or some other type of storing medium (a computer-readable medium, a compact disk (CD), a digital versatile disk (DVD), etc.). Memory/storage 510 may include a hard disk (e.g., a magnetic disk, an optical disk, a magneto-optic disk, a solid state disk, etc.) or some other type of storing medium, along with a corresponding drive. Memory/storage 510 may be external to and/or removable from device 500, such as, for example, a Universal Serial Bus (USB) memory, a dongle, a hard disk, mass storage, off-line storage, etc.

The term “computer-readable medium,” as used herein, is intended to be broadly interpreted to include, for example, a memory, a storage medium, a CD, a DVD, a Blu-ray disc, or another type of tangible storing medium. Memory/storage 510 may store data, application(s), and/or instructions related to the operation of device 500.

Application 515 may include software that provides various services and/or functions. For example, with reference to network device 310, application 515 may include one or multiple applications pertaining to content manager 312. Additionally, for example, with reference to network device 410, application 515 may include one or multiple applications pertaining to advertiser manager 412. Also, for example, with reference to user device 315, application 515 may include one or multiple applications pertaining to content manager 317. Additionally, for example, with reference to user device 415, application 515 may include one or multiple applications pertaining to advertiser manager 417.

Communication interface 520 may permit device 500 to communicate with other devices, networks, systems, etc., illustrated in network 100. Communication interface 520 may include one or multiple wireless interfaces and/or wired interfaces. Communication interface 520 may include one or multiple transmitters, receivers, and/or transceivers. Communication interface 520 may operate according to one or multiple protocols, standards, and/or the like.

Input 525 may permit an input into device 500. For example, input 525 may include a keyboard, a mouse, a camera, a scanner, a microphone, a display, a touchpad, a button, a switch, an input port, voice recognition logic, fingerprint recognition logic, a web cam, and/or some other type of visual, auditory, tactile, etc., input component. Output 530 may permit an output from device 500. For example, output 530 may include a speaker, a display, a light, an output port, and/or some other type of visual, auditory, tactile, etc., output component.

As described herein, device 500 may perform processes in response to processing system 505 executing software instructions (e.g., application 515) stored by memory/storage 510. By way of example, the software instructions may be read into memory/storage 510 from another memory/storage 510 or from another device via communication interface 520. The software instructions stored by memory/storage 510 may cause processing system 505 to perform one or more processes described herein. Alternatively, for example, according to other implementations, device 500 may perform one or more processes described herein based on the execution of hardware (processing system 505, etc.), the execution of hardware and firmware, or the execution of hardware, software, and firmware.

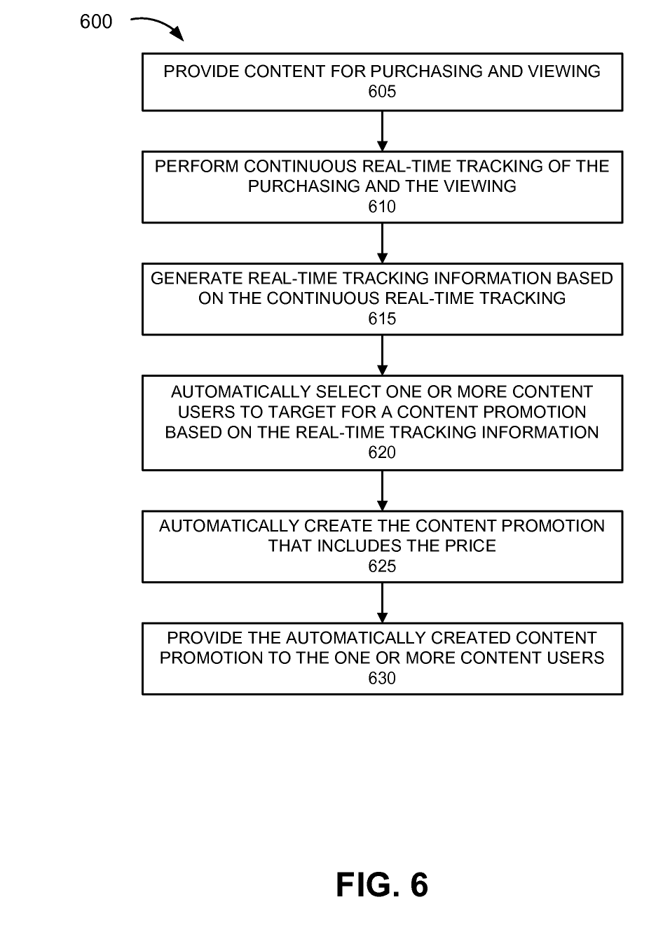

FIG. 6 is a flow diagram illustrating an exemplary process 600 for automatically creating a content promotion to users based on real-time tracking information. According to an exemplary embodiment, one or more operations of process 600 may be performed by the content manager.

Process 600 may include providing content for purchasing and viewing (block 605). For example, DMR network 305 may provide content for purchasing and viewing by content users. Content users may buy or rent content. Additionally, other purchasing and/or viewing options pertaining to content may be available to users, such as, for example, rent content with an ad, buy or rent content without an ad, rent content with replay capability, combinations thereof, etc.

Continuous real-time tracking of the purchasing and the viewing may be performed (block 610). For example, the content manager may perform real-time tracking of the purchasing and the viewing of content by users. For example, as previously described, the real-time tracking pertaining to content users may include the tracking of real-time metrics associated with content user behavior (e.g., content purchased (e.g., content bought to own, content rented, etc.), content viewed, format of content (e.g., content with ads, content without ads, with replay capability, without replay capability, etc.), content searched, content users' interaction with ads, content users' rankings of content, content user's recommendations of content to other content users, etc.), usage patterns (e.g., time of usage, frequency of usage, location of usage, content user device used, etc.), self-identified attributes (e.g., content user profile information (e.g., age, gender, etc.), content user preferences, content user-voting of content, etc.), other content users behavior (e.g., friends of the content user, other content users, etc.), velocity of purchasing over time pertaining to a particular content or group of content, etc.

Additionally, as previously described, content users may purchase and view content across multiple user devices. For example, a content user may purchase and/or view content on a television, a handheld device, a computer, etc. In this regard, the real-time tracking may be based on a content user's behavior, usage patterns, etc., using multiple user devices. Additionally, the content user may be identified based on a manual log-in or automatically identified.

Real-time tracking information may be generated based on the real-time tracking (block 615). For example, the content manager may compile information obtained from the real-time tracking, format the information, and store the information so that the information (e.g., real-time tracking information) may be used by the content manager, other devices in DMR network 305, other devices in network 100, etc. As previously described, the real-time tracking information may form a basis to create various categories or groupings of content users (e.g., individually, household, preferences to genre, by age, by education, all content users, etc.).

One or more content users to target for a content promotion may be automatically selected based on the real-time tracking information (block 620). For example, the content manager may automatically select one or more content users to target for the content promotion based on the real-time tracking information. The content manager may assess content user behavior, which may indicate a positive or a negative trend pertaining to the purchasing and the viewing of content, and automatically select one or more content users to increase profit, revenue, etc., and provide these content user(s) a personalized content provisioning service. For example, according to an exemplary scenario, the content manager may recognize a recent positive trend in purchasing and viewing pattern (e.g., within the past week) corresponding to when a content user commutes to and from work. Based on the content user's purchasing and viewing pattern trend, the content manager may select the content user to target for a content promotion.

The content promotion that includes a price and content may be automatically created (block 625). For example, the content manager may automatically create the content promotion based on the real-time tracking information and/or the targeted one or more users. For example, the content promotion may include an offering of a bundle of content, a-la-carte content, a portion of content, etc. The content manager may automatically select the content based on heuristics, financial performance information (e.g., content sales, current sales targets, etc.), etc. The content manager may also automatically select an appropriate price based on demand forecasts, price elasticity, sales and margin targets, etc.

The automatically created content promotion may be provided to the one or more content users (630). For example, the content manager may make the automatically created content promotion available to the one or more users via one or more user devices and DMR network 305.

Although FIG. 6 illustrates exemplary operations for automatically creating content promotion to users based on real-time tracking information, according to other exemplary embodiments, process 600 may include additional operations, fewer operations, and/or different operations than those illustrated and described.

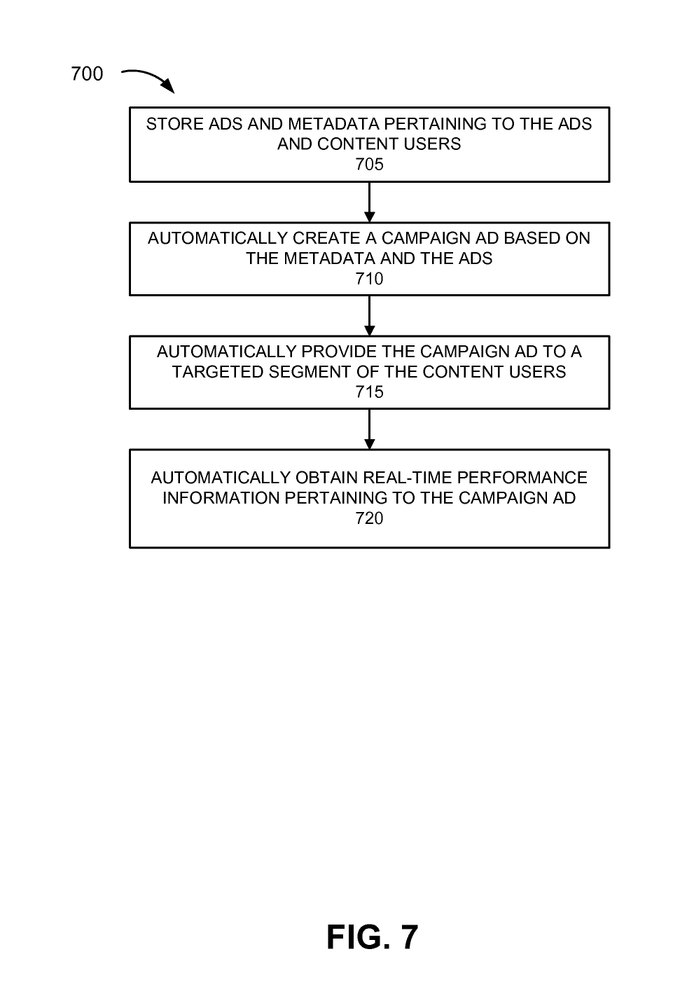

FIG. 7 a flow diagram illustrating an exemplary process 700 for automatically creating a campaign ad. According to an exemplary embodiment, one or more operations of process 700 may be performed by the advertiser manager.

Process 700 may include storing ads and metadata pertaining to the ads and content users (block 705). For example, advertiser network 405 may store an inventory of ads and metadata pertaining to the ads and content users. Alternatively, for example, the ads and metadata may be stored in DMR network 305, by DDC 150, some combination of the above, etc. As previously described, the metadata pertaining to the ads may include, for example, a brand of a product, a type or a category of product, product attributes, a cost of a product, etc. Additionally, the metadata pertaining to the content users may include demographic information. For example, the demographic information may include age, ethnicity, income, education, gender, community affiliations, membership in social networks, purchasing and viewing history, interaction with other ad campaigns, etc.

A campaign ad may be automatically created based on the stored ads and metadata (block 710). For example, the advertiser manager may automatically create an ad campaign based on the available ads and the metadata. Additionally, for example, the advertiser manager may automatically create an ad campaign based on advertising objectives associated with a client, a previous campaign ad, a currently running campaign ad (e.g., which may be under-performing or over-performing relative to target financial data, target impressions, etc.), and/or a campaign ad is defined by an ad user and the advertiser manager may recommend a campaign ad based on the defined campaign ad. The advertiser manager may use various heuristics, algorithms, etc., to match particular ads with a targeted segment of the content users. As previously described, the advertiser manager may automatically select the type of ad, the position of the ad, the frequency of the ad, the time period for the ad, a geographic location, types of user device(s), etc.

The campaign ad may be automatically provided to a targeted segment of the content users (block 715). For example, the advertiser manager may make the automatically created campaign ad available to the targeted segment of the content users via one or more user devices and DMR network 305.

Real-time performance information pertaining to the campaign ad may be automatically obtained (block 720). For example, the advertiser manager may perform continuous real-time tracking of the campaign ad. For example, the continuous real-time tracking may include the tracking of real-time metrics associated with the campaign ad and the targeted segment of content users. For example, as previously described, the real-time metrics pertaining to the campaign ad and the targeted segment of content users may include the number of impressions, the quality of impressions, user device used, etc. Additionally, as previously described, the real-time metrics pertaining to the campaign ad may include, for example, conventional and advanced financial data, such as CPM, CPE, CPA, total budget, etc. The advertiser manager may generate real-time performance information based on the real-time tracking For example, the advertiser manager may compile information obtained from the real-time tracking, format the information, and store the information so that the information may be used by the advertiser manager, other devices in advertiser network 405, DMR network 305, other devices in network 100, etc. According to another embodiment, the advertising manger may obtain the real-time performance information from other network devices (e.g., in DMR network 305, DDC 150, etc.).

Although FIG. 7 illustrates exemplary operations for automatically creating a campaign ad, according to other exemplary embodiments, process 700 may include additional operations, fewer operations, and/or different operations than those illustrated and described.

In the foregoing description, content users may be afforded access to a repository of content under one subscription service. The content may be purchased (e.g., owned, rented) and viewed using various types of user devices. The subscription service may manage the storage of all content purchased, provide various personalized services, and allow the content user a versatility in selecting and viewing content, etc.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

While a series of blocks have been described with regard to exemplary processes illustrated in FIGS. 6 and 7, the order of the blocks may be modified according to other embodiments. In addition, non-dependent blocks may be performed parallel. Furthermore, other processes described in this description may be modified and/or non-dependent operations may be performed in parallel.

The exemplary embodiments described herein may be implemented in many different forms of software, firmware, and/or hardware. For example, a process or a function may be implemented as “logic” or as a “component.” This logic or this component may include, for example, hardware (e.g., processing system 505, etc.), a combination of hardware and software (e.g., applications 515), a combination of hardware and firmware, or a combination of hardware, firmware, and software. The embodiments have been described without reference to a specific software code, a specific hardware or circuit configuration, etc., since the logic or the component can be designed to implement the embodiments based on the description herein.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

No element, act, or instruction described in the specification and/or drawings should be construed as critical or essential to the exemplary embodiments described herein unless explicitly described as such.

What is claimed is:

1. A method comprising:
providing content for purchasing and viewing by users, wherein the purchasing includes buying or renting content;
performing real-time tracking pertaining to the purchasing and the viewing of content by the users based on the providing;
generating real-time tracking information based on the performing, wherein the real-time tracking information includes information that identifies a content purchased by the user and a user device used by the user to view the content;
automatically selecting one or more of the users to target a content promotion based on the real-time tracking information;
automatically creating the content promotion based on the selecting, wherein the content promotion includes a price for purchasing and at least one of a combination of an advertisement and content or content; and
providing the automatically created content promotion to the one or more users.

2. The method of claim 1, further comprising:
automatically recognizing positive or negative trends pertaining to viewership of a particular content or pertaining to advertisement sales based on the real-time tracking information; and
automatically calculating a price elasticity for an ad slot for the particular content based on the recognized positive or negative trends.

3. The method of claim 1, further comprising:
automatically recognizing positive or negative trends pertaining to viewership of a particular content based on the real-time tracking information;
automatically creating a promotional bundle of content based on the recognized positive or negative trends; and
automatically calculating one or more prices for the promotional bundle of content wherein the one or more prices are different based on at least one of the user device used by a user or a location of the user.

4. The method of claim 1, further comprising:
providing real-time summary information pertaining to ad sales performance and ad inventory, wherein the real-time summary information includes information pertaining at least one of ad sale figures, net number of impressions, average cost-per-thousand, cost-per-action, or cost-per-engagement achieved for a period of time;
automatically identifying one or more ad slots for content that have not sold;
automatically identifying one or more unsold ads;
automatically analyzing the identified content having the one or more ad slots not sold and the identified one or more unsold ads based on metadata associated with the identified content and the identified one or more unsold ads, wherein the analyzing includes identifying whether a common theme or a common attribute between the identified content and the identified one or more unsold ads exists based on the metadata; and
automatically creating a buy-package that includes the identified content and the identified one or more unsold ads when it is determined that the common theme or the common attribute exists.

5. The method of claim 1, wherein the automatically selecting further comprises automatically selecting the one or more users based on demographics pertaining to the one or more users, wherein the demographics include at least one of age, gender, income level, ethnicity, education, or location, and the method further comprising:
accessing global content usage data that includes purchasing and viewing habits of users that subscribe to other content providers, and wherein the automatically creating further comprises automatically creating the content promotion based on the purchasing and the viewing habits associated with the users that subscribe to the other content providers.

6. The method of claim 1, further comprising:
providing real-time performance information pertaining to the content promotion; and
permitting a change in the price associated with the content promotion, before an end date associated with the content promotion, based on the real-time performance information pertaining to the content promotion.

7. A method comprising:
storing advertisements (ads) and metadata, wherein the metadata pertains to the ads and demographic information associated with content users that purchase and view content that includes ads;
automatically creating an ad campaign based on the metadata, demographic information, and available ads, wherein the ad campaign includes specifying one or more types of ads, one or more positions of the one or more types of ads relative to content, a time period for the ad campaign, a frequency that the ad campaign is to run, a target audience that includes one or more content users, and one or more types of user devices on which the ad campaign is to be viewed by the one or more content users;
automatically providing the ad campaign for delivery to the one or more content users; and
automatically obtaining real-time performance information pertaining to the ad campaign during the time period for the ad campaign.

8. The method of claim 7, wherein the demographic information includes at least one of gender, ethnicity, education, income, age, or geographic area associated with the one or more content users, wherein the one or more types of ads includes at least one of a companion banner ad, an in-stream video ad, an opening slate, a branded player skin that includes a screen theme corresponding to a theme of the content with which the branded player skin is positioned, or an interactive bug, and wherein the one or more positions include at least one of a pre-roll position, a mid-roll position, a post-roll position, during an in-stream video, or during a requested video.

9. The method of claim 7, wherein the automatically creating comprises:
automatically creating the ad campaign based on at least one of patterns of usage pertaining to viewing and purchasing of content by the one or more content users, patterns of usage pertaining to viewing and purchasing of content by other content users, historical data pertaining to the one or more content users' interaction with a similar campaign ad, a rating of an ad pertaining to a previously viewed ad by the one or more content users, a community affiliation of the one or more content users, or a membership in a social network by the one or more content users.

10. The method of claim 9, further comprising:
determining a similarity between the campaign ad and the similar campaign ad based on at least one of metadata associated with each campaign ad or metadata associated with one or more content users that were targeted by the similar campaign ad and metadata associated with the one or more content users to be targeted by the campaign ad.

11. The method of claim 7, wherein the real-time performance information includes quality of impressions information and financial performance information including at least one of return on investment information, cost-per-action, cost-per-engagement, cost-per-thousand, or financial target information.

12. The method of claim 7, further comprising:
automatically recommending an adjustment to the campaign ad before the time period for the campaign ad expires based on the real-time performance information.

13. A system comprising at least one component configured to:
perform real-time tracking pertaining to purchasing and viewing of content by users;
generate real-time tracking information based on the performing, wherein the real-time tracking information, at an identified user level across one or multiple user devices associated with a user, includes a content purchased by the user and a user device used by the user to view the content;
automatically select one or more of the users to target a content promotion based on the real-time tracking information; and
automatically create the content promotion based on the selecting, wherein the content promotion includes a price for purchasing and at least one of a combination of an advertisement and a content or a content.

14. The system of claim 13, wherein the at least one component is further configured to:
automatically recognize positive or negative trends pertaining to viewership of a particular content or pertaining to advertisement sales based on the real-time tracking information; and
automatically calculate a price elasticity for an ad slot for the particular content based on the recognized positive or negative trends.

15. The system of claim 13, wherein the at least one component is further configured to:
automatically recognize positive or negative trends pertaining to viewership of a particular content based on the real-time tracking information;
automatically create a promotional bundle of content based on the recognized positive or negative trends; and
automatically calculate one or more prices for the promotional bundle of content wherein the one or more prices are different based on at least one of the user device used by a user or a location of the user.

16. The system of claim 13, wherein the at least one component is further configured to:
provide real-time summary information pertaining to ad sales performance and ad inventory, wherein the real-time summary information includes at least two of ad sale figures, net number of impressions, average cost-per-thousand, cost-per-action, or cost-per-engagement achieved for a period of time;
automatically identify one or more ad slots for content that have not sold;
automatically identify one or more unsold ads;
automatically analyze the identified content having the one or more ad slots not sold and the identified one or more unsold ads based on metadata associated with the identified content and the identified one or more unsold ads, wherein the analyzing includes identifying whether a common theme or a common attribute between the identified content and the identified one or more unsold ads exists based on the metadata; and
automatically create a buy-package that includes the identified content and the identified one or more unsold ads when it is determined that the common theme or the common attribute exists.

17. The system of claim 13, wherein the at least one component is further configured to:
provide real-time performance information pertaining to the content promotion; and
permit a change in the price associated with the content promotion, before an end date associated with the content promotion, based on the real-time performance information pertaining to the content promotion.

18. The system of claim 13, wherein the at least one component is further configured to:
automatically recognize positive or negative purchasing trends associated with particular users and a particular content; and
automatically adjusting a price associated with the particular content based on the positive or negative trends, wherein the adjusting maximizes revenue and profit with respect to the particular users and the particular content.

19. A system comprising at least one component configured to:
store advertisements (ads) and metadata, wherein the metadata pertains to the ads and demographic information associated with content users that purchase and view content that includes ads;
automatically create an ad campaign based on the metadata, demographic information, and available ads, wherein the ad campaign includes at least two of specifying one or more types of ads, one or more positions of the one or more types of ads relative to content, a time period for the ad campaign, a frequency that the ad campaign is to run, a target audience that includes one or more content users, or one or more types of user devices on which the ad campaign is to be viewed by the one or more content users;
automatically provide the ad campaign for delivery to the one or more content users; and
automatically obtain real-time performance information pertaining to the ad campaign during the time period for the ad campaign.

20. The system of claim 19, wherein the demographic information includes at least one of gender, ethnicity, education, income, age, or geographic area associated with the one or more content users, wherein the one or more types of ads includes at least one of a companion banner ad, an in-stream video ad, an opening slate, a branded player skin that includes a screen theme corresponding to a theme of the content with which the branded player skin is positioned, or an interactive bug, and wherein the one or more positions include at least one of a pre-roll position, a mid-roll position, a post-roll position, during an in-stream video, or during a requested video.

21. The system of claim 19, wherein when automatically creating, the at least one component is further configured to:
automatically create the ad campaign based on at least one of patterns of usage pertaining to viewing and purchasing of content by the one or more content users, patterns of usage pertaining to viewing and purchasing of content by other content users, historical data pertaining to the one or more content users' interaction with a similar campaign ad, a rating of an ad pertaining to a previously viewed ad by the one or more content users, a community affiliation of the one or more content users, or a membership in a social network by the one or more content users.

22. The system of claim 21, wherein the at least one component is further configured to:
determine a similarity between the campaign ad and the similar campaign ad based on at least one of metadata associated with each campaign ad or metadata associated with one or more content users that were targeted by the similar campaign ad and metadata associated with the one or more content users to be targeted by the campaign ad.

23. The system of claim 19, wherein the real-time performance information includes quality of impressions information and financial performance information including at least one of return on investment information, cost-per-action, cost-per-engagement, cost-per-thousand, or financial target information, and the at least one component is further configured to:
automatically recommend an adjustment to the campaign ad before the time period for the campaign ad expires based on the real-time performance information.

24. The system of claim 19, wherein the adjustment includes at least one of changing at least one of the one or more types of ads, the one or more positions of the one or more types of ads relative to content, the time period for the ad campaign, the frequency that the ad campaign is to run, the target audience, or the one or more types of user devices on which the ad campaign is to be viewed by the target audience.
